(19) United States
(12) Patent Application Publication
(10) Pub. No.: US 2019/0235727 A1
(43) Pub. Date: Aug. 1, 2019

(54) ELECTRONIC DEVICE INCLUDING TOUCH KEY

(71) Applicant: Samsung Electronics Co., Ltd., Gyeonggi-do (KR)

(72) Inventor: Woong-Sun HONG, Gyeonggi-do (KR)

(21) Appl. No.: 16/316,651

(22) PCT Filed: Jun. 27, 2017
(86) PCT No.: PCT/KR2017/006744

§ 371 Date: Jan. 10, 2019

(30) Foreign Application Priority Data
Jul. 28, 2016 (KR) 10-2016-0096035

(51) Int. Cl. G06F 3/041; G06F 3/044

(52) U.S. Cl. CPC G06F 3/04144; G06F 2203/04107; G06F 3/044; G06F 3/0418

(57) ABSTRACT

An electronic device according to various embodiments of the present invention may comprise: a housing; a touch key which is disposed on one surface of the housing and includes a touch module surrounded in a closed space; and a pressure sensor for sensing changed pressure of an air layer of the closed space according to external force exerted on the touch key. An electronic device as described above can be variously implemented according to embodiments.

### TECHNICAL FIELD

Various embodiments of the present disclosure relate to an electronic device. For example, the various embodiments relate to an electronic device including a touch key.

### BACKGROUND ART

Electronic devices may mean devices that perform specific functions according to programs incorporated therein. Such devices include electronic schedulers, portable multimedia reproducers, mobile communication terminals, tablet PCs, image/sound devices, desktop PCs, laptop PCs, or vehicular navigation systems, as well as home appliances. The above-mentioned electronic devices may, for example, output information stored therein as sounds or images. As the degree of integration of such electronic devices has increased and super-high speed and large capacity wireless communication has become popular, various functions have recently been provided in a single electronic device, such as a mobile communication terminal. For example, various functions, such as entertainment functions (e.g., a game function), multimedia functions (e.g., a music/video reproducing function), communication and security functions for mobile banking, schedule management functions, and e-wallet functions, are integrated in a single electronic device, in addition to communication functions.

Such electronic devices are provided in various kinds of methods. For example, an electronic device may include a touch screen on which the user performs input by directly touching a screen using a finger or an electronic pen. In addition, an electronic device may include a touch key as well as a touch screen, so that basic functions such as menu execution, reverting, and undo can be intuitively performed through touch input.

### DETAILED DESCRIPTION OF THE INVENTION

### Technical Problem

An electronic device that implements touch keys may include a capacitive touch module. When the user touches a portion outside of the touch keys, the touch module may not detect the user's touch. In order to solve such a problem, the size of the touch module may be increased, such that the user can have a wider range to touch the touch module. However, increasing the size of the touch module may be a factor that increases the cost of the electronic device.

Meanwhile, a pressure sensor having a structure stacked with a touch module may be included in order to sense the pressure corresponding to a user's touch. Such a pressure sensor has a multi-layered structure and is arranged by being stacked with a touch module, thereby causing the problem of increasing the thickness of the electronic device. In recent years, as electronic devices have become thinner, it may be difficult to secure a space for arranging a pressure sensor so that it is stacked with a touch module.

Accordingly, an electronic device, according to various embodiments of the present disclosure, is configured such that manufacturing costs are reduced while the range capable of being touched by a user is increased without increasing the size of the touch module.

In addition, an electronic device, according to various embodiments of the present disclosure, is configured such that a pressure sensor senses a user's touch input together with a touch module even though the pressure sensor is not stacked with the touch module. In addition, an electronic device, according to various embodiments of the present disclosure, is configured such that various inputs of a user can be sensed by sensing the position of the user's touch using a touch module and by sensing a user's touch input using a pressure sensor.

### Technical Solution

An electronic device according to various embodiments of the present disclosure may include: a housing; a touch key positioned on one face of the housing and including a touch module surrounded by a closed space; and a pressure sensor configured to sense a pressure of an air layer in the closed space changed according to an external force applied to the touch key.

An electronic device according to various embodiments of the present disclosure may include: a housing; a touch key positioned on one face of the housing and including a touch module surrounded by a closed space; a pressure sensor configured to sense a pressure of an air layer in the closed space changed according to an external force applied to the touch key; and a control unit configured to receive an electric signal from the touch module and an electric signal from the pressure sensor so as to control the operation of the electronic device.

A method of operating an electronic device according to various embodiments of the present disclosure may include: sensing the position of a user's touch; measuring a pressure value of an air layer changed in a closed space; determining the pressure value as a correction value according to the touch position; and generating an input signal corresponding to the input position and the correction value.

Advantageous Effects

An electronic device, according to various embodiments of the present disclosure, is provided with the pressure sensor that senses pressure of the air layer changed in a closed space, which results from a user's input, and thus the pressure sensor may not be stacked with the touch module. That is, since the pressure sensor is not stacked with the touch module, it is possible to prevent the thickness of the electronic device from increasing. In addition, in the electronic device, according to various embodiments of the present disclosure, various input signals according to the position of the user's touch can be sensed using the touch module, and various input signals according to the pressure of a user's touch can be sensed using the pressure sensor. In addition, in the electronic device, according to various embodiments of the present disclosure, various input signals can be generated according to a combination of touch position and touch pressure according to a user's input.

### BRIEF DESCRIPTION OF DRAWINGS

FIG. 1 is a perspective view illustrating the front face of an electronic device according to various embodiments of the present disclosure;

FIG. 2 is a perspective view illustrating the rear face of the electronic device according to various embodiments of the present disclosure;

FIG. 3 is an exploded perspective view illustrating an electronic device according to various embodiments of the present disclosure;

FIG. 4 is a cross-sectional view illustrating an electronic device according to various embodiments of the present disclosure;

FIG. 5 is a plan view illustrating the inside of an electronic device according to various embodiments of the present disclosure;

FIG. 6 is an enlarged view of a portion “A” in FIG. 5;

FIG. 7 is a perspective view illustrating a recess, a touch module, and a pressure sensor of an electronic device according to various embodiments of the present disclosure;

FIG. 8 is a cross-sectional view schematically illustrating an electronic device according to various embodiments of the present disclosure;

FIG. 9A is a cross-sectional view illustrating an operation of an electronic device according to various embodiments of the present disclosure;

FIG. 9B is an enlarged view of a portion “B” in FIG. 9A, illustrating the state in which a user touches a first position of a touch key;

FIG. 9C is an enlarged view of the portion “B” in FIG. 9A, illustrating the state in which a user touches a position different from the first position of a touch key;

FIG. 10A is a plan view illustrating an operation of an electronic device according to various embodiments of the present disclosure;

FIG. 10B is an enlarged view of a touch panel, pressure sensors, and recesses in the electronic device illustrated in FIG. 10A;

FIG. 11 is a block diagram of an electronic device according to various embodiments of the present disclosure;

FIG. 12 is a flowchart illustrating an input method of an electronic device according to various embodiments of the present disclosure;

FIG. 13 is a perspective view illustrating the front face of an electronic device according to one of various embodiments of the present disclosure; and

FIG. 14 is a perspective view illustrating the rear face of the electronic device according to another one of various embodiments of the present disclosure.

| | |
|---|---|
| 100: Electronic device | 101: Housing |
| 103: Cover member | 114a, 114b, 115a, 115b: Recess |
| 151, 153: Touch module | 171, 173: Pressure sensor |

### MODE FOR CARRYING OUT THE INVENTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The terms used in the present disclosure are only used to describe specific embodiments, and are not intended to limit the present disclosure. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

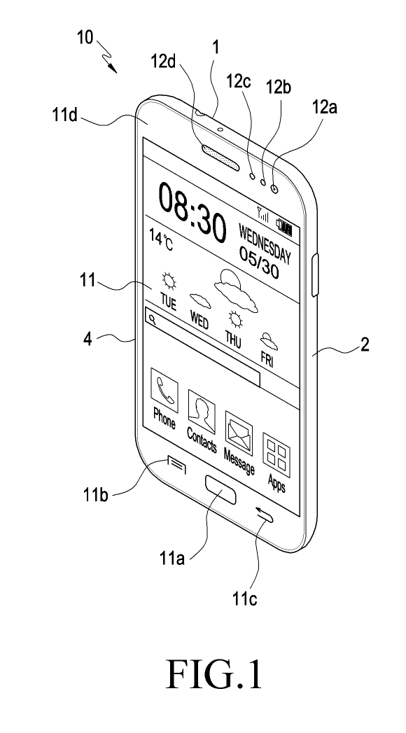

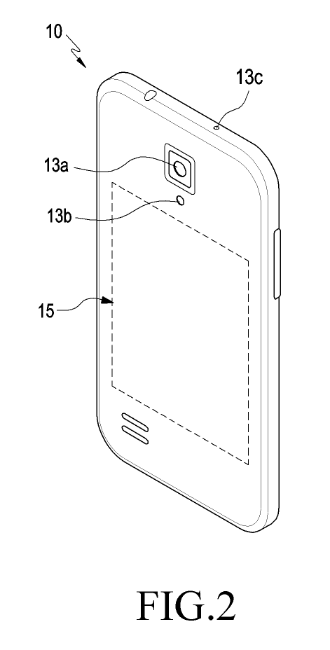

FIG. 1 is a perspective view illustrating the front face of an electronic device according to various embodiments of the present disclosure; FIG. 2 is a perspective view illustrating the rear face of the electronic device according to various embodiments of the present disclosure;

The electronic device 10 may be a smartphone or a wearable device. Components of an electronic device, such as a smartphone, will be described with reference to FIGS. 1 and 2.

As illustrated in FIG. 1, an electronic device 10 may include a touch screen 11 disposed in the center of the front face thereof The touch screen 11 may occupy a large portion of the front face of the electronic device 10. FIG. 1 illustrates an example in which a main home screen is displayed on the touch screen 11. The main home screen refers to the first screen that is displayed on the touch screen 11 when the power of the electronic device 10 is turned on. In addition, when the electronic device 10 has several pages of different home screens, the main home screen may be the first home screen among the several pages of home screens. The home screen may display shortcut icons to execute frequently used applications, a main menu switching key, time, weather, or the like. The main menu switching key may cause a menu screen to be displayed on the touch screen 11. In addition, in the upper end of the touch screen 11, status bars 11b may be disposed to indicate the statuses of the device, such as a battery charge status, a received signal strength, and the current time. Below the touch screen 11, touch keys such as a home key 11a, a menu button 11b, and a back button 11c may be disposed.

The home key 11a may cause the main home screen to be displayed on the touch screen 11. For example, when the home key 11a is touched in the state where any home screen that is different from the main home screen, or the menu screen, is displayed on the touch screen 11, the main home screen may be displayed on the touch screen 11. In addition, when the home key 11a is touched while applications are being executed on the touch screen 11, the main home screen may be displayed on the touch screen 11. In addition, the home key 11a may be used for causing the most recently used application or a task manager to be displayed on the touch screen 11. The menu button 11b may provide a connection menu that is capable of being used on the touch screen 11. The connection menu may include, for example, a widget addition menu, a background screen change menu, a retrieve menu, an edition menu, or an environment setting menu. The back button 11c may cause the screen, which has been executed just prior to the currently executed screen, to be displayed, or may cause the most recently used application to be terminated.

For example, the home key 11a may include therein an electronic component such as a fingerprint sensor so as to receive a user's fingerprint input. In addition to fingerprint recognition, the home key 11a may include therein various electronic components such as a Heart-Rate Monitor (HRM) so as to be utilized as a function key. The home key 11a including a fingerprint recognition sensor unit may be utilized not only as a function key for simultaneously driving the electronic device when it is pressed, but also may perform a click operation.

According to various embodiments of the present disclosure, as illustrated in FIG. 1 described above, a first camera 12a, an illuminance sensor 12b, or a proximity sensor 12c may be included in the upper end region of the front face of the electronic device 10.

As illustrated in FIG. 2, a second camera 13a, a flash 13b, or a speaker 13c may be included on the rear face of the electronic device 10. When the electronic device 10 is configured such that a battery pack is detachably mounted thereon, the rear face of the electronic device 10 may be a detachable battery cover 15.

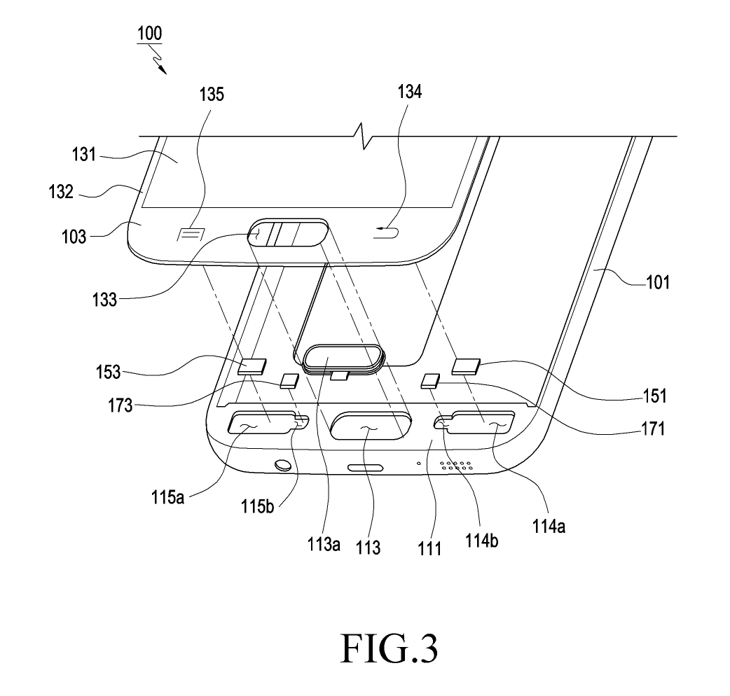

FIG. 3 is an exploded perspective view illustrating an electronic device according to various embodiments of the present disclosure.

Referring to FIG. 3, an electronic device 100 according to various embodiments of the present disclosure may be the electronic device 10 illustrated in FIG. 1. The electronic device 100 may include a housing 101, a cover member 103, a support member 111, a home key 113a, touch keys 134 and 135 including touch modules 151 and 153, and pressure sensors 171 and 173.

The housing 101 may protect the inside of the electronic device 100 while forming the external appearance of the electronic device 100. The housing 101 may be made of, for example, a metal material. A portion of the housing (e.g., the side face of the housing 101) may be made of a metal material, and the other portion of the housing 101 may be made of a synthetic material. The housing 101 made of a metal material or a portion of the housing 101 may be used as an antenna radiator of the electronic device 100. In addition, a first circuit board 118 is provided inside the housing 101, and the first circuit board 118 may perform the function of a main circuit board by being mounted with a control unit, a storage unit, a communication circuit unit, and the like required for driving the electronic device.

The cover member 103 may be located on the front face of the housing 101. The cover member 103 is capable of transmitting a screen output through the display module while protecting the display module installed inside the housing 101. The cover member 103 may be made of glass or a transparent reinforced plastic film. The cover member 103 may include a visible region 131 in which the screen is output and a bezel region 132 surrounding the visible region. The bezel region 132 is capable of blocking the wiring or the like of the display module from being exposed to the outside while protecting the cover member 103 of the visible region. Touch keys, such as a home key 113a, a menu button 135, and a back button 134, may be disposed in the lower end of the bezel region 132. A through hole 133 is provided in the lower end of the bezel region 132, and the home key 113a may be provided such that it is capable of being pressed while being exposed through the through hole 133.

The touch modules 151 and 153 may be attached to the bezel region 103 of the cover member 103. The plurality of touch modules 151 and 153 may be arranged symmetrically with respect to the home key 133a.

The support member 111 may be provided in the housing 101 so as to provide a plurality of recesses 113, 114a, 114b, 115a, and 115b. The plurality of recesses 113, 114a, 114b, 115a, and 115b may include a main recess 113 that accommodates the home key 113a, first recesses 114a and 115a that accommodate a plurality of touch modules 151 and 153, and second recesses 114b and 115b that accommodate a plurality of pressure sensors 171 and 173. The plurality of recesses 113, 114a, 114b, 115a, and 115b may have a rectangular parallelepiped shape. However, the plurality of recesses 113, 114a, 114b, 115a, and 115b are not limited to being a rectangular parallelepiped shape, and may be formed in various shapes such as an elliptical shape.

The pressure sensors 171 and 173 are capable of sensing the changed pressure of the air layer of each of the first recesses 114a and 115a in the state of being accommodated in the second recesses 114b and 115b, respectively. However, the air layer is not limited to air, and various gases or liquids may be included therein. According to various embodiments of the present disclosure, the pressure sensors 171 and 173 are not limited to being accommodated in the second recesses 114b and 115b, but may be accommodated in the first recesses 114a and 115a together with the touch modules 151 and 153. Also, according to various embodiments of the present disclosure, the pressure sensors 171 and 173 may be disposed at various positions connected to the first recesses 114a and 115a. In addition, the pressure sensors 171 and 173 may be piezo pressure sensors. However, the pressure sensors 171 and 173 are not limited to being piezo-electric pressure sensors, and may be various sensors capable of sensing a change in pressure.

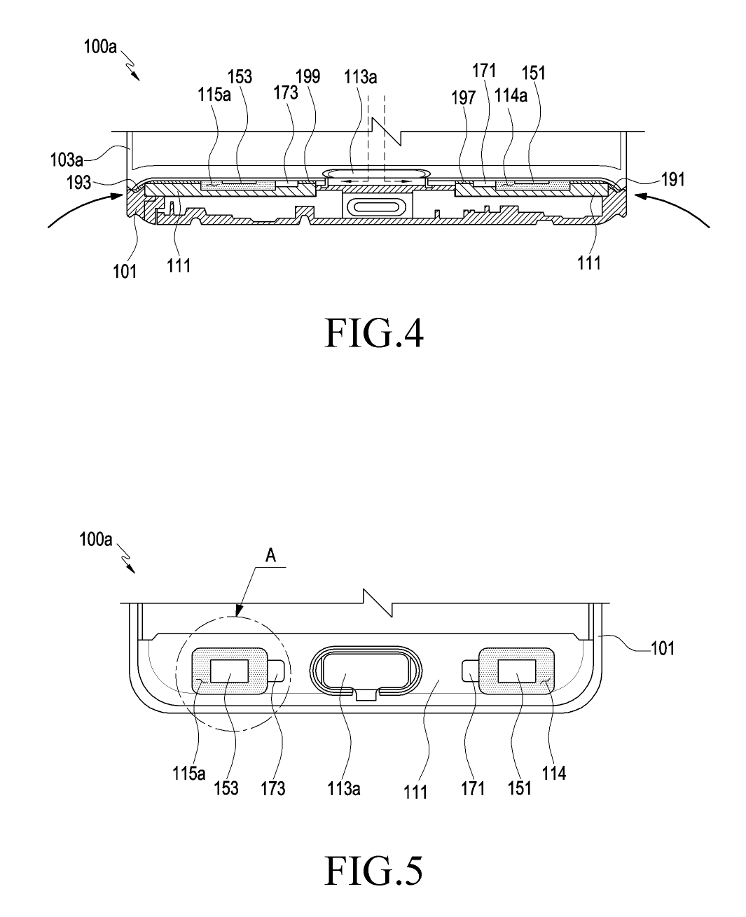

FIG. 4 is a cross-sectional view illustrating an electronic device according to various embodiments of the present disclosure.

Referring to FIG. 4, an electronic device 100a according to various embodiments of the present disclosure may include a cover member 103a and sealing members 191, 193, 197, and 199, each having curved faces at both sides thereof. The components of may be the same as or similar to those of the preceding embodiment, except for the curved face of the cover member 103a.

The sealing members 191, 193, 197, and 199 may seal a gap between the cover member 103a and the support member 111. The sealing members 191, 193, 197, and 199 may be double-sided tape having a predetermined thickness. However, the sealing members 191, 193, 197 and 199 are not limited to being double-sided tape, but may be various adhesives applied in a liquid form. The sealing members 191, 193, 197, and 199 may include first sealing members 191 and 193 that block the infiltration of fluid between the opposite side ends of the housing 101 and second sealing members 197 and 199 that block infiltration of fluid through the periphery of the home key 113a. The first sealing members 191 and 193 not only seal the gap between the support member 111 and the cover member 103a, but also seal the gap between the housing 101 and the cover member 103a, thereby preventing fluids from flowing into the recesses 114a and 115a between opposite side ends of the housing 101. In addition, the first sealing members 191 and 193 are capable of preventing fluids from flowing into the housing 101 through the opposite side ends of the housing 101. The second sealing members 197 and 199 are capable of sealing the gap between the support member 111 and the cover member 103a adjacent to the home key 113a, thereby preventing fluids from flowing into the recesses 114a and 115a through the home key 113a. In addition, the second sealing members 197 and 199 are capable of preventing fluids from flowing into the housing 101 through the home key 113a. The sealing members 191, 193, 197, and 199 are capable of preventing an external fluid from flowing into the recesses 114a and 115a and closing the recesses 114a and 115a. That is, the sealing members 191, 193, 197, and 199 seal the gap between the cover member 103 and the support member 111 so as to form a closed space between the cover member 103 and the support member 1111. A plurality of recesses 114a and 115a may be included in the closed space.

Since the plurality of touch modules 151 and 153 and the plurality of pressure sensors 171 and 173 are arranged parallel to each other, it is possible to reduce the thickness of the electronic device compared to a structure in which a touch module and a pressure sensor of a conventional electronic device are stacked.

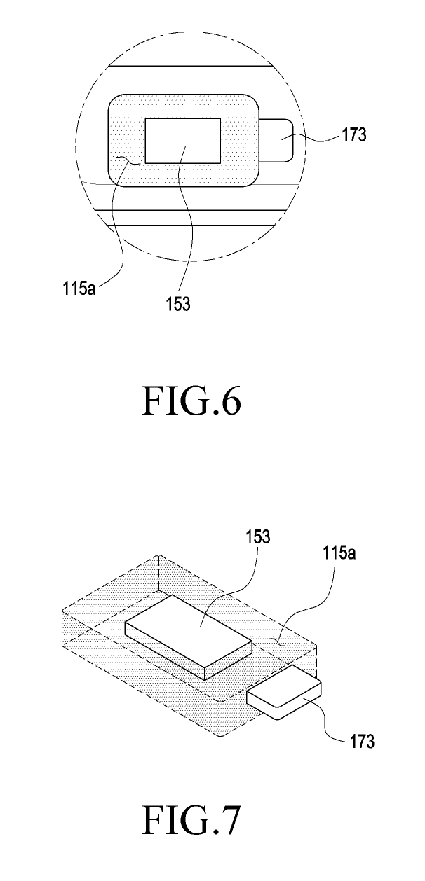

FIG. 5 is a plan view illustrating the inside of the electronic device according to various embodiments of the present disclosure. FIG. 6 is an enlarged view of a portion “A” in FIG. 5. FIG. 7 is a perspective view illustrating a recess, a touch module, and a pressure sensor of the electronic device according to various embodiments of the present disclosure.

Referring to FIGS. 5 to 7, the recesses 114a and 115a may be sealed between the cover member and the support member 111 to include an air layer. The sizes of the recesses 114a and 115a may be larger than the sizes of the touch modules 151 and 153. The air layer existing in the recesses 114a and 115a may surround the periphery of the touch module 153 (e.g., the side face or the bottom face of the touch module 153).

The pressure sensors 171 and 173 may be connected to the recesses 114a and 115a so as to sense the changed pressure of the air layer.

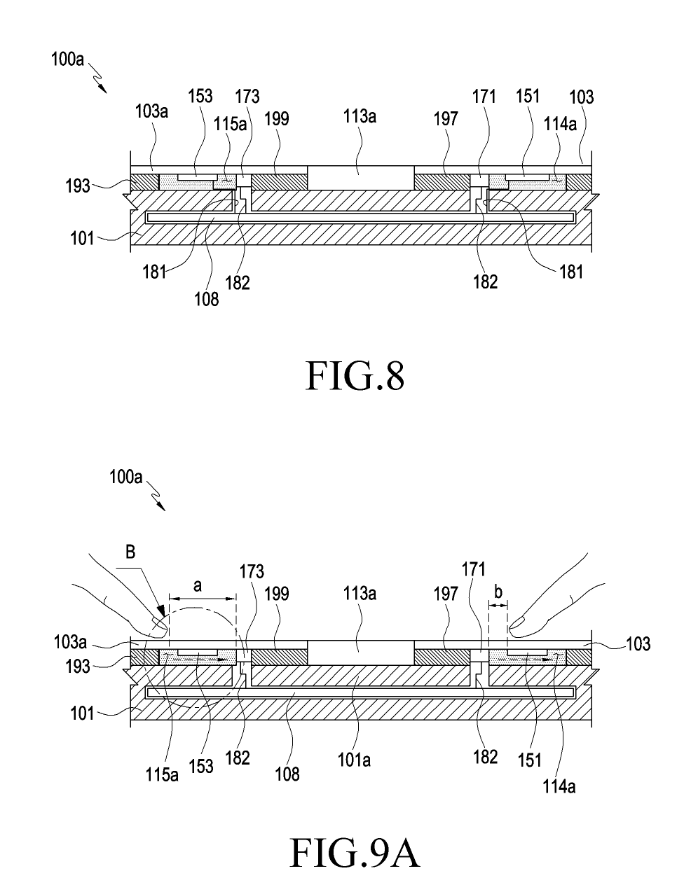

FIG. 8 is a cross-sectional view schematically illustrating an electronic device according to various embodiments of the present disclosure.

Referring to FIG. 8, an electronic device 100a, according to various embodiments of the present disclosure, may include a second circuit board 108, a first conducting line 181, and a second conducting line 182.

The second circuit board 108 may be electrically connected to the first circuit board 118 (FIG. 1) while being mounted in the housing 101.

The first conducting line 181 may electrically connect the second circuit board 108 and the touch modules 151 and 153. Electrical signals of the touch modules 151 and 153 may be transmitted to a control unit (not illustrated) through the first conducting line 181, the second circuit board 108, and the first circuit board. The first conducting line 181 may pass through a first through hole (not illustrated) of the housing 101 so as to connect the second circuit board 108 and the touch modules 151 and 153. The through hole through which the first conducting line 181 passes may be sealed so as to maintain the closed state of the first recess 115a.

The second conducting line 182 may electrically connect the second circuit board 108 and the pressure sensors 171 and 173. Electrical signals of the pressure sensors 171 and 173 may be transmitted to the control unit through the second conducting line 182, the second circuit board 108, and the first circuit board. The second conducting line 182 may pass through a second through hole of the housing 101 so as to connect the second circuit board 108 and the pressure sensors 171 and 173. The second through hole through which the second conducting line 182 passes may be sealed so as to maintain the closed state of the second recess. In addition, according to various embodiments of the present disclosure, a device that connects the second circuit board 108 and the pressure sensors 171 and 173 is not limited to being the second conducting line 182, but may be various connectors. The connectors may pass through the housing 101, and a gap between the connectors and the housing 101 may be sealed so as to maintain the closed state of the air layer in the second recess. According to various embodiments of the present disclosure, the touch module and the pressure sensors may be directly mounted on the second circuit board.

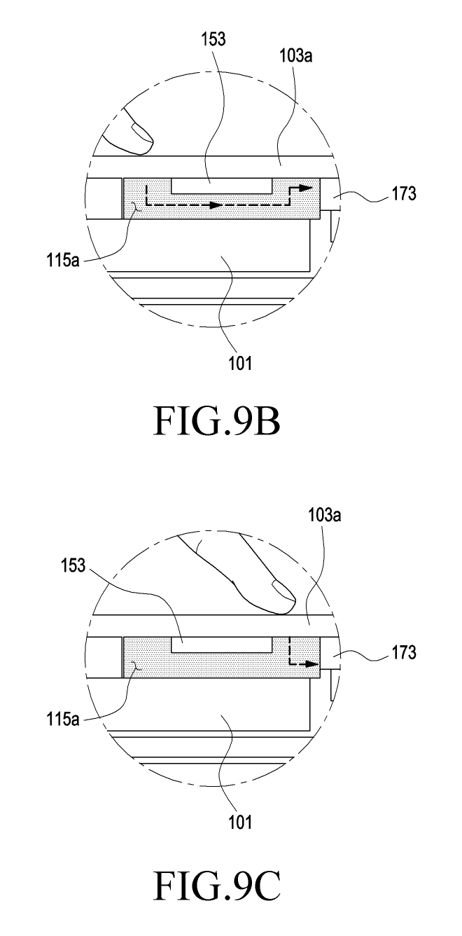

FIG. 9A is a cross-sectional view illustrating an operation of an electronic device according to various embodiments of the present disclosure. FIG. 9B is an enlarged view of a portion “B” in FIG. 9A, illustrating the state in which a user touches a first position of a touch key. FIG. 9C is an enlarged view of the portion “B” in FIG. 9A, illustrating the state in which a user touches a position different from the first position of a touch key.

Referring to FIGS. 9A to 9C, when a user applies an external force on a first position \textcircled{1} of the cover member 103a above the recess 115, the touch module 151 is capable of sensing the position of the user's touch. The air layer of the recess 115a accommodating one of the touch modules 151 may be moved by an external force applied by the user.

Meanwhile, measurement values measured from the pressure sensors 171 and 173 may be different depending on the positions pressed by the user even if the cover member 103a is pressed with the same pressure. For example, when the first position is spaced apart from the pressure sensor 173 by a length a and an external force is applied to the first position, the air layer of the recess 115a may be moved toward the pressure sensor 173. At this time, the pressure sensor 173 is capable of measuring the measured value of the pressure changed by the movement of the air layer. In addition, the measured value of the pressure sensor 173 may be increased depending on the external force applied by the user.

Further, when the user applies an external force on the second position, the air layer of the recess 114a can be moved in a direction away from the pressure sensor 171. For example, the second position may be spaced apart from the pressure sensor 171 by a distance b shorter than the length a. When an external force is applied to the second position, the pressure sensor 173 is capable of measuring a measurement value smaller than the measurement value measured due to the external force applied to the first position. That is, the measurement value measured by the pressure sensor due to the external force of the first magnitude on the first position may be larger than the measurement value measured by the pressure sensor due to the external force of the first magnitude on the second position. Likewise, as illustrated in FIG. 9C, when the user applies an external force on another position that is closer than the first position from the pressure sensor 173, the measurement value of the pressure sensor 173 due to the external pressure applied to the other position may be smaller than the measurement value of the pressure sensor 173 due to the external force applied to the first position.

When the user continuously touches the first position or the second position, the pressure sensors 171 and 173 are capable of measuring an equilibrium pressure value according to the volumes of the recesses 114a and 115b.

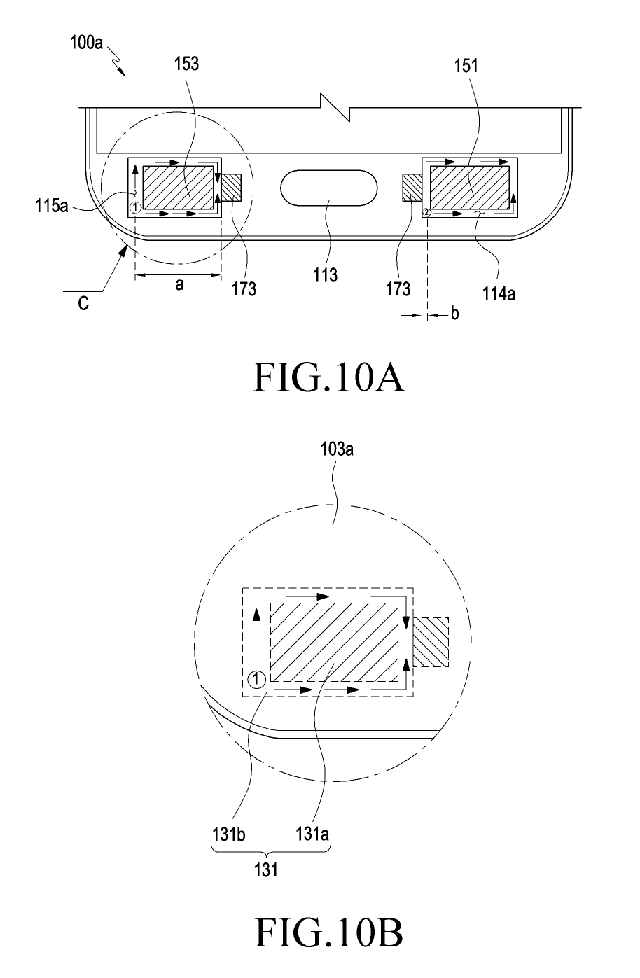

FIG. 10A is a plan view illustrating an operation of an electronic device according to various embodiments of the present disclosure. FIG. 10B is an enlarged view of a touch panel, a pressure sensor, and a recess in the electronic device illustrated in FIG. 10A.

Referring to FIGS. 10A and 10B, when the user applies an external force having a first magnitude to the first position \textcircled{1}, the measurement value measured by the pressure sensor 173 may be larger than the measurement value measured by the pressure sensor 171 when the external force having the first magnitude is applied to the second position \textcircled{2}.

On the other hand, when the user touches the peripheral portion on a touch module, the touch module of the conventional electronic device may fail to sense the user's touch.

In order to solve such a problem, the touch key 131 of the electronic device 100a, according to various embodiments of the present disclosure, may include a first region 131a in which the touch module 153 senses the user's touch, and a second region 131b which surrounds the first region 131a and in which the user's touch is sensed.

The touch module 153 is capable of sensing an external force (e.g., the user's touch) applied to the first region 131a.

The air layer of the recess 115a may exist in correspondence with the second region 131b, as well as the first region 131a, while surrounding the touch module 153. When the user applies an external force to the second region 131b, the pressure sensor 173 is capable of sensing the changed pressure of the air layer of the recess 115a. That is, the electronic device 100a, according to various embodiments of the present disclosure, is capable of sensing the user's touch in a wider region than compared to an electronic device having a conventional touch module.

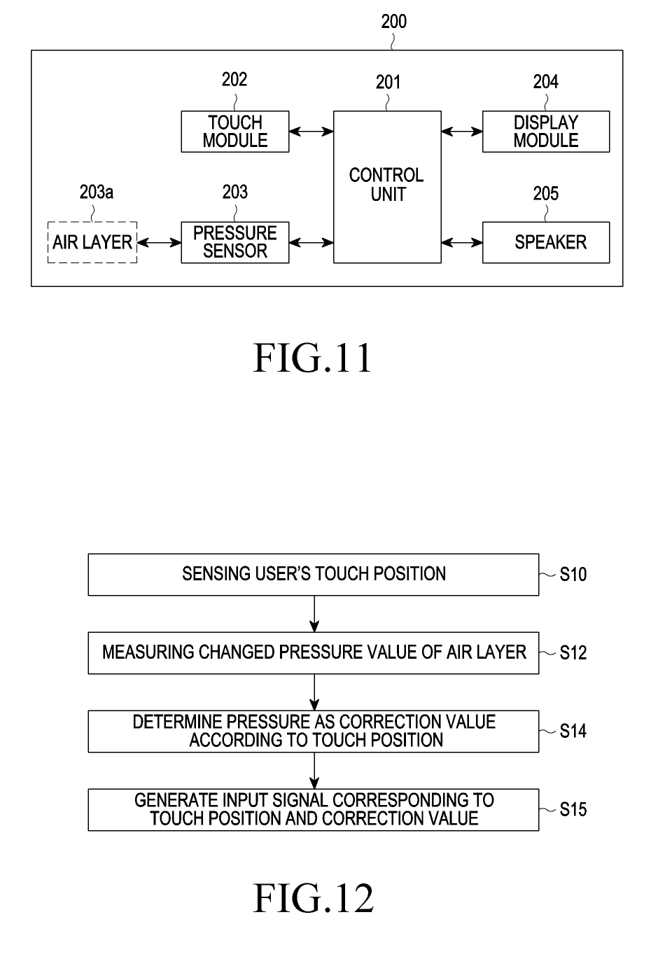

FIG. 11 is a block diagram of an electronic device according to various embodiments of the present disclosure.

Referring to FIG. 11, an electronic device 200 according to various embodiments of the present disclosure may be the above-described electronic device (e.g., the electronic device 10 illustrated in FIG. 1, the electronic device 100 illustrated in in FIG. 3, or the electronic device 100a illustrated in FIG. 4). The electronic device 200 may include a control unit 201, a touch module 202, a pressure sensor 203, a display module 204, and a speaker 205.

The control unit 201 may include a Central Processing Unit (CPU). The control unit 201 may perform operations or data execution concerning control and/or communication of the components of the electronic device 200 (e.g., the touch module 202, the pressure sensor 203, the display module 204, and the speaker 205). In addition, the controller 201 is capable of correcting the pressure measurement value, which varies depending on the distance from the pressure sensor 203 even if the cover member is pressed with the same pressure. For example, the control unit 201 may convert the measurement value measured from the pressure sensor 203 into a correction value according to the position of the user's touch. The control unit 201 may generate an input signal corresponding to the touch position and the correction value.

The touch module 202 may be implemented in a capacitive manner. The touch module 202 may sense the touch position by the user's touch input. The touch module 202 may transmit an electrical signal corresponding to the touch position to the control unit 201.

The pressure sensor 203 may transmit an electrical signal to the control unit 201 according to the pressure change of the air layer 203a.

The display module 204 may receive various input signals from the control unit 201 to implement various screens.

The speaker 205 may receive various input signals from the control unit 201 so as to generate various sounds. The control unit 201 may transmit various input signals to the speaker 205 so as to adjust the magnitude of the sound generated by the speaker 205.

FIG. 12 is a flowchart illustrating an input method of an electronic device according to various embodiments of the present disclosure.

An input method of an electronic device, according to various embodiments of the present disclosure, may include an operation of sensing the position of the user's touch (S10), an operation of measuring a changed pressure value of an air layer (S12), an operation of determining a pressure value as a correction value according to the touch position (S13), and an operation of generating an input signal corresponding to the touch position and the correction value (S15).

The operation of sensing the position of the user's touch (S10) may be an operation of sensing a touch position from a change in capacitance of the touch module when the user touches the cover member.

The operation of measuring the pressure value applied to the touch position (S12) may be an operation of measuring by the pressure sensor a pressure measurement value that is changed depending on the movement of the air layer in the recess due to the pressure applied to the position of the user's touch.

The operation of determining the pressure value as a correction value according to the touch position (S13) may be an operation of determining by the control unit the measurement value as a correction value according to the distance between the touch position and the pressure sensor.

The operation of generating an input signal corresponding to the touch position and the correction value (S15) may be an operation of generating various input signals corresponding to the touch position and the correction value in the control unit, and the various input signals may correspond to an image implemented from the display module.

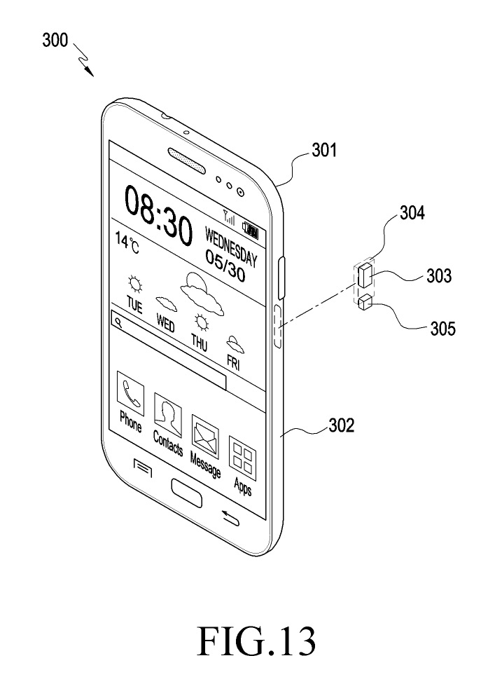

FIG. 13 is a perspective view illustrating the front face of an electronic device according to one of various embodiments of the present disclosure.

Referring to FIG. 13, an electronic device 300, according to one of various embodiments of the present disclosure, may include a housing 301, a touch module 303, and a pressure sensor 305. A description of components, which are the same as or similar to those of the preceding embodiments, will be omitted.

The touch module 303 may be disposed on a side face 302 of the housing 301. The touch module 303 may be disposed in a closed space 304. An air layer may be formed in the closed space 304. The pressure sensor 305 may be connected to the closed space 304 so as to sense the changed pressure of the air layer.

As described above, since the electronic device 300, according to one of various embodiments of the present disclosure, includes the touch module 303 and the pressure sensor 305 that senses the changed pressure of the air layer surrounding the touch module 303 on the side face 302 of the housing, various input signals can be created when the user touches the side face 302 of the housing in the state of gripping the electronic device. For example, when a music application is driven in the electronic device 300, the user is able to adjust the volume of the sound according to the force pressing the side face 302 of the housing on the touch module 303 and the closed space 304. In addition, depending on the force applied by pressing the side face 302 of the housing on the touch module 303 and the closed space 304, the user may switch the music played in the music application to different music.

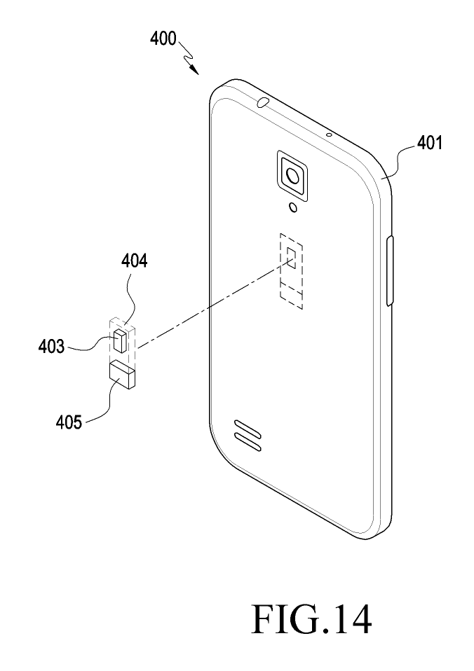

FIG. 14 is a perspective view illustrating the rear face of the electronic device according to another one of various embodiments of the present disclosure.

Referring to FIG. 14, an electronic device 400, according to one of various embodiments of the present disclosure, may include a housing 401, a touch module 403, and a pressure sensor 405. A description of components, which are the same as or similar to those of the preceding embodiments, will be omitted.

The touch module 403 may be disposed on the rear face of the housing 401. The touch module 403 may be disposed in a closed space 404. An air layer may be formed in the closed space 404. The pressure sensor 405 may be connected to the closed space 404 so as to sense the changed pressure of the air layer.

As described above, since the electronic device 400, according to one of various embodiments of the present disclosure, includes the touch module 403 and the pressure sensor 405 that senses the changed pressure of the air layer surrounding the touch module 403 on the rear face of the housing, various input signals can be created when the user touches the rear face of the housing in the state of gripping the electronic device. For example, when a camera application is driven in the electronic device 400, the user is able to implement a zoom operation of the camera lens of the electronic device according to the force of pressing the rear face of the housing on the touch module 403 and the closed space 404. In addition, when the force of pressing the rear face of the housing on the touch module 403 and the closed space 404 by the user corresponds to a preset value, the camera is able to capture an image.

As described above, an electronic device according to various embodiments of the present disclosure may include: a housing; a touch key positioned on one face of the housing and including a touch module surrounded by a closed space; and a pressure sensor configured to sense pressure of an air layer in the closed space changed according to an external force applied to the touch key.

In addition, according to various embodiments of the present disclosure, the housing may include: a cover member on which the touch key is disposed; a support member provided in the housing and configured to accommodate the touch module; and a sealing member configured to seal a gap between the cover member and the support member and to form the closed space between the cover member and the support member.

In addition, according to various embodiments of the present disclosure, the support member may provide a plurality of recesses, and the plurality of recesses may be included in the closed space.

In addition, according to various embodiments of the present disclosure, the plurality of recesses may include first recesses configured to accommodate a plurality of touch modules, and second recesses configured to accommodate a plurality of pressure sensors, and the first recesses and the second recesses may be connected to each other.

In addition, according to various embodiments of the present disclosure, the first recesses have a larger size than the size of the touch modules.

In addition, according to various embodiments of the present disclosure, the electronic device may further include: a first circuit board accommodated in the housing; a second circuit board electrically connected to the first circuit board; a first conducting line electrically connecting the second circuit board and the touch module such that an electric signal related to a touch position sensed by the touch module moves through the first conducting line; and a second conducting line electrically connecting the second circuit board and the pressure sensor such that an electric signal related to a pressure resulting from a user's touch input moves through the second conducting line.

In addition, according to various embodiments of the present disclosure, a plurality of touch modules and a plurality of pressure sensors may be disposed parallel to each other.

In addition, according to various embodiments of the present disclosure, the electronic device may include: a housing; a touch key positioned on one face of the housing and including a touch module surrounded by a closed space; a pressure sensor configured to sense pressure of an air layer in the closed space changed according to an external force applied to the touch key; and a control unit configured to receive an electric signal from the touch module and an electric signal from the pressure sensor so as to control the operation of the electronic device.

In addition, according to various embodiments of the present disclosure, a measurement value measured by the pressure sensor when an external force of a first magnitude is applied to a first position may be larger than a measurement value measured by the pressure sensor when an external force having the first magnitude to a second position, which is closer to the pressure sensor than the first position.

In addition, according to various embodiments of the present disclosure, the touch module may sense the position of a user's input, and the control unit may determine the measurement values as a correction value corrected according to a distance between the position of the user's input and the pressure sensor.

In addition, according to various embodiments of the present disclosure, the control unit may generate an input signal corresponding to the input position and the correction value.

In addition, according to various embodiments of the present disclosure, the electronic device may further include a display module mounted on the cover member, and the control unit may control the display module to display an image corresponding to the input signal.

In addition, according to various embodiments of the present disclosure, the touch module may sense an external force applied to a first region of the touch key thereon, and the pressure sensor may sense an external force applied to any one of the first region and a second region surrounding the first region so as to sense a region wider than a region sensed by the touch module.

A method of operating an electronic device according to various embodiments of the present disclosure may include: sensing the position of the user's touch; measuring pressure value of an air layer changed in a closed space; determining the pressure value as a correction value according to the touch position; and generating an input signal corresponding to the touch position and the correction value.

In the foregoing detailed description, specific embodiments of the present disclosure have been described. However, it will be evident to a person ordinarily skilled in the art that various modifications may be made without departing from the scope of the present disclosure.

1. An electronic device comprising:
a housing;
a touch key positioned on one face of the housing and including a touch module surrounded by a closed space; and
a pressure sensor configured to sense pressure of an air layer in the closed space changed according to an external force applied to the touch key.

2. The electronic device of claim 1, wherein the housing includes:
a cover member on which the touch key is disposed;
a support member provided in the housing and configured to accommodate the touch module; and
a sealing member configured to seal a gap between the cover member and the support member and to form the closed space between the cover member and the support member.

3. The electronic device of claim 2, wherein the support member provides a plurality of recesses, and the plurality of recesses are included in the closed space.

4. The electronic device of claim 3, wherein the plurality of recesses include first recesses configured to accommodate a plurality of touch modules, and second recesses configured to accommodate a plurality of pressure sensors, and
the first recesses and the second recesses are connected to each other.

5. The electronic device of claim 4, wherein the first recesses have a size larger than a size of the touch modules.

6. The electronic device of claim 1, further comprising:
a first circuit board accommodated in the housing;
a second circuit board electrically connected to the first circuit board;
a first conducting line electrically connecting the second circuit board and the touch module such that an electric signal related to a touch position sensed by the touch module moves through the first conducting line; and
a second conducting line electrically connecting the second circuit board and the pressure sensor such that an electric signal related to a pressure resulting from a user's touch input moves through the second conducting line.

7. The electronic device of claim 1, wherein a plurality of touch modules and a plurality of pressure sensors are disposed parallel to each other.

8. An electronic device comprising:
a housing;
a touch key positioned on one face of the housing and including a touch module surrounded by a closed space;
a pressure sensor configured to sense pressure of an air layer in the closed space changed according to an external force applied to the touch key; and
a control unit configured to receive an electric signal from the touch module and an electric signal from the pressure sensor so as to control an operation of the electronic device.

9. The electronic device of claim 8, wherein a measurement value measured by the pressure sensor when an external force of a first magnitude is applied to a first position is larger than a measurement value measured by the pressure sensor when an external force having the first magnitude to a second position, which is closer to the pressure sensor than the first position.

10. The electronic device of claim 8, wherein the touch module senses a user's input position, and
the control unit determines the measurement values as correction values corrected according to a distance between the user's input position and the pressure sensor.

11. The electronic device of claim 10, wherein the control unit generates an input signal corresponding to the input position and the correction value.

12. The electronic device of claim 11, further comprising:
a display module mounted on the cover member,
wherein the control unit controls the display module to display an image corresponding to the input signal.

13. The electronic device of claim 8, wherein the touch module senses an external force applied to a first region of the touch key thereon, and
the pressure sensor senses an external force applied to any one of the first region and a second region surrounding the first region so as to sense a region wider than a region sensed by the touch module.

14. A method of operating an electronic device, comprising:
sensing a user's touch position;
measuring a pressure value of an air layer changed in a closed space;
determining the pressure value as a correction value according to the touch position; and
generating an input signal corresponding to the touch position and the correction value.
